(19) United States
(12) Patent Application Publication
(10) Pub. No.: US 2003/0154335 A1
(43) Pub. Date: Aug. 14, 2003

(54) Encoding element for an electric module and electric module including such encoding element

(75) Inventor: Jens Krause, Rahden (DE)

Correspondence Address: Norman P. Soloway, HAYES SOLOWAY P.C., 130 W. Cushing Street, Tucson, AZ, 85701, US

(73) Assignee: HARTING Automotive GmbH & Co. KG

(21) Appl. No.: 10/360,187

(22) Filed: Feb. 7, 2003

(30) Foreign Application Priority Data
Feb. 11, 2002 (DE) 102 05 556.4

(51) Int. Cl. G06F 13/00

(52) U.S. Cl. 710/100

(57) ABSTRACT

An encoding element for an electric module comprises at least one cutting edge which is provided to sever one of a plurality of conductor tracks arranged on a substrate, whereby the electric module is assigned an address. There is also proposed an electric module including such encoding element.

### TECHNICAL FIELD

The invention relates to an encoding element for an electric module, in particular for a serial bus system. The invention further relates to an electric module including such an encoding element.

### BACKGROUND OF THE INVENTION

Serial bus systems are dependent on each subscriber to the bus communication having an individual address. This allows a precisely directed transmission of information.

When several modules of the same type are connected to a bus system, it is of great importance for logistic reasons to be able to treat these parts as identical parts. These parts are not to be individualized until by assembly at the place of installation.

Disclosed in the prior art is the use of encoding switching contacts which are operated at the place of installation such that the module is assigned an individual address. Since switching contacts of such type need to be highly reliable, high costs are incurred.

The object of the present invention consists in attaining a reliable encoding of the electric module during assembly, involving little expenditure.

### BRIEF SUMMARY OF THE INVENTION

According to the invention, an encoding element for an electric module comprises at least one cutting edge which is provided to sever one of a plurality of conductor tracks arranged on a substrate, whereby the electric module is assigned an address. The invention is based on the fundamental concept of encoding an electric module by destroying at least one of a plurality of conductor tracks. The condition of the plurality of conductor tracks, which are provided solely for this purpose, can be enquired from an electronic circuit. Depending on the result of this enquiry, the circuit will then assign a particular address to the electric module. Since it is very simple to destroy a conductor track mechanically, namely by means of the cutting edge of the encoding element, the costs of encoding performed in this manner are very much lower than the costs of the switching contacts used in the prior art.

In the embodiments in accordance with the invention it is important that once the encoding element has severed the appropriate conductor track, it prevents any parasitic contacts due to the ends of the severed conductor track springing back. This is reliably ensured if the cutting edge is made of an electrically insulating material. In contrast, if the cutting edge is made of metal, it is preferably embedded in a holding part made of an electrically insulating material, the electrically insulating material ensuring that the two conductor ends are insulated from each other -in the final position of the encoding element.

According to a preferred embodiment of the invention, provision is made that the cutting edge is provided on one side thereof with a flat contact surface which cooperates with a cutting die plate provided at the electric module. The cutting die plate serves as an abutment and facilitates the severing of the conductor tracks and of the substrate.

According to a preferred embodiment of the invention, the encoding element is provided with at least one centering pin adapted to engage in an opening in the substrate. The centering pin serves to guide the encoding element when the cutting edge of the encoding element separates the substrate. The opening in the substrate serves to limit any further tearing of the substrate to the area between two opposite openings, for example. Provision may be made additionally for such an opening to be provided with a notch in the tearing direction for facilitating initial tearing of the substrate.

According to a preferred embodiment of the invention, provision is made that the encoding element is designed as a mating connector which may be plugged into the electric module. Different encoding elements are provided for encoding one and the same electric module, which differ in their coloration, for example. The cutting edges of the different encoding elements are arranged at different locations so that upon insertion of the encoding element only one specific conductor track is disrupted at a time and the desired encoding is obtained in this way.

According to an alternative embodiment provision is made that the encoding element is designed as a slide which is mounted for sliding movement on the electric module. The encoding element can then be shifted between different positions, much like a switching contact. Only when the encoding element is in the desired position are arrangements made that the substrate with the conductor tracks is pressed onto the area provided with the encoding element and, as a result, the conductor tracks are destroyed. This may be effected for example in that the electric module, in the condition as delivered, has an open housing cover which is not closed until the encoding element has been brought into the desired position for the purpose of encoding. When the housing cover is closed, it presses the substrate against the encoding element such that the appropriate conductor track is disrupted.

The invention further relates to an electric module comprising a mount for an encoding element. Such an electric module may be supplied always in the same configuration. The individual address required for use in the bus system is not given to the electric module until on insertion of the respective individual encoding element.

Advantageous further developments of the invention will be apparent from the dependent claims.

### BRIEF DESCRIPTION OF THE DRAWINGS

FIG. 1 shows a diagrammatic, perspective view of an encoding element before it is pressed onto the substrate to sever a conductor track;

FIG. 2 shows another perspective view of the encoding element and the substrate of FIG. 1;

FIG. 3 shows another embodiment of the encoding element in a perspective view;

FIG. 4 shows a diagrammatic sectional view of a conductor track as disrupted by a cutting edge in accordance with a variant of an embodiment;

FIG. 5 shows a diagrammatic sectional view of a conductor track as disrupted by a cutting edge in accordance with another variant of an embodiment;

FIG. 6 shows a sectional view of an encoding element with a cutting edge in accordance with a further variant of an embodiment;

FIG. 7 shows a diagrammatic sectional view of an electric module in accordance with the invention;

FIG. 8 shows an enlarged top view of a substrate with a plurality of conductor tracks, the substrate being used in the electric module of FIG. 7 and being in the condition prior to encoding; and

FIG. 9 shows the substrate with the conductor tracks of FIG. 8, with an encoding having been performed.

### DETAILED DESCRIPTION OF THE PREFERRED EMBODIMENTS

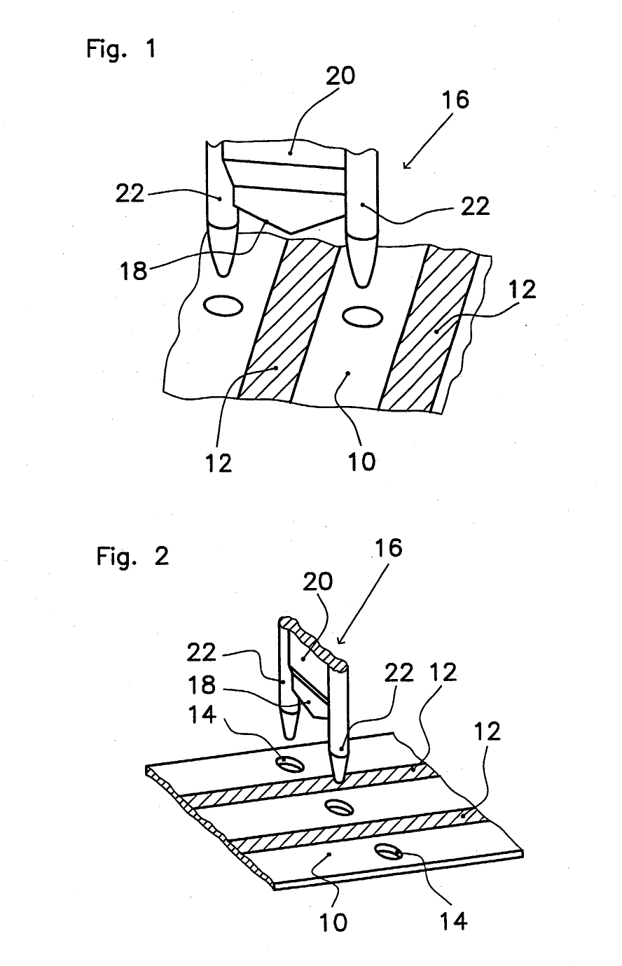

FIGS. 1 and 2 show a substrate 10, which is provided with a plurality of conductor tracks 12. The substrate may be more particularly a flexible printed circuit sheet. The substrate has a plurality of openings 14 provided therein, which are located in pairs on either side of a conductor track 12.

An encoding element 16 is shown which in the embodiment according to FIGS. 1 and 2 includes a cutting edge 18 arranged in a holding part 20. At each lateral end of the cutting edge 18 there is arranged a centering pin 22 having a tapered front end and a diameter which roughly corresponds to the diameter of the openings 14.

The encoding element 16 is provided to be placed onto the substrate 10 such that the cutting edge 18 severs that one of the conductor tracks 12 which is located between the two openings 14 which are engaged by the centering pins 22.

Cutting the appropriate conductor track 12 in two is facilitated in the encoding element according to FIGS. 1 and 2 by the cutting edge 18 consisting of two obliquely arranged sections which meet in the middle to form a point. Any unintentional further tearing of the substrate in areas not cut through by the cutting edge 18 is reliably prevented by the openings 14, which serve as tear stop means.

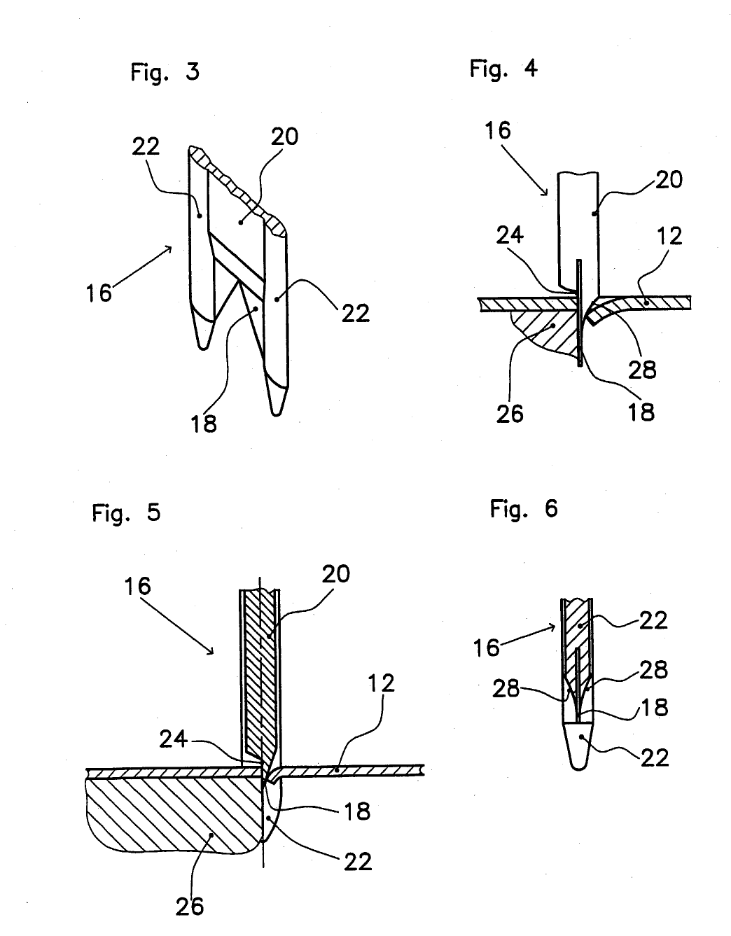

FIG. 3 shows an encoding element having an alternative configuration of the cutting edge 18. In contrast to the embodiment shown in FIGS. 1 and 2, here the sections of the cutting edge 18 are arranged in such a way that they form a notch extending to the rear in the direction of insertion; that is, when the encoding element 16 is inserted the cutting edge 18 will first engage the substrate in the area of the openings 14. Initial tearing of the substrate may be assisted by providing small notches at the edges of the openings 14 on an imaginary connecting line between the two openings.

In FIG. 4 an encoding element 16 can be seen in section, in which the cutting edge 18 is made of metal and is embedded in the holding part 20. The holding part 20 consists of an insulating synthetic material. One side of the cutting edge 18, namely the side on the left in FIG. 4, is formed as a flat contact surface 24, which cooperates with a cutting die plate 26 arranged on the rear side of the substrate. The cutting die plate 26 is a part of an electric module (see FIG. 7) and serves to support the substrate 10 during the cutting operation so as to ensure a clean cut. On that side of the cutting edge 18 opposite the contact surface 24, the holding part 20 is provided with a curved deflection surface 28, which ensures that the end of the disrupted conductor track 12 on the right-hand side of the cutting edge 18 will not touch the cutting edge 18. In this way it is made sure that the electrically conductive cutting edge 18 will not produce any unintentional contact between the actually separated ends of the conductor track 12.

FIG. 5 shows an alternative configuration of the encoding element 16. In contrast to the encoding element shown in FIG. 4, in this configuration the cutting edge 18 is made in one piece with the holding part 20; that is, the cutting edge 18 is made of an electrically insulating material. The advantage compared with the encoding element shown in FIG. 4 resides in that it is prevented with an even higher reliability that the encoding element establishes a contact between the actually separated ends of the conductor track 12. In addition, an encoding element made entirely of a synthetic material may be produced very inexpensively. The disadvantage resides in that a cutting edge made of a synthetic material can not usually be made as sharp as a cutting edge made of metal so that the forces required for placing the encoding element onto the substrate are greater.

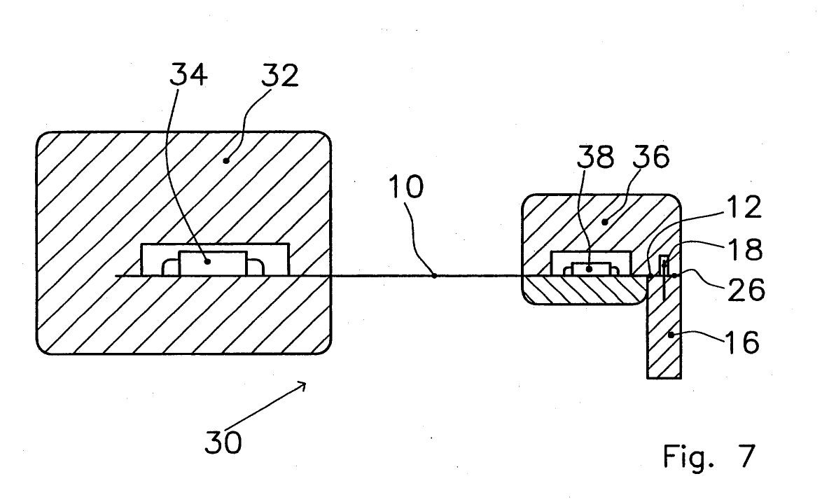

FIG. 6 shows a further variant for embodying an encoding element in which, similar to the encoding element of FIG. 4, a cutting edge 18 made of metal is employed. However, in the encoding element according to FIG. 6 the deflection surface 28 is provided on both sides of the cutting edge 18. This results in a larger spatial separation of the ends of the disrupted conductor track from each other.

FIG. 7 shows an electric module 30, which may be a weight sensor, for example, which is used to detect an occupation of a vehicle seat. Each vehicle seat has its own weight sensor associated with it; all of the weight sensors together communicate with a central control unit via a bus system.

The electric module 30 consists of a sensor 32, of which a sensor circuit 34 is shown here diagrammatically. The sensor circuit 34 is arranged on an electric circuit substrate in the form of a flexible conductor sheet that is identical with the substrate 10. Further arranged on the substrate 10 is an address component 36 provided with an address circuit 38. The encoding element 16 can be inserted into the address component 36. The encoding element 16 is designed as a mating connector, the number of different variants that are available for it corresponding to the number of different encodings desired. The different encoding elements all fit into one and the same mount provided on the address component 36 and they differ only in regard to the arrangement of the cutting edge 18. In order that the different encoding elements can be told apart during assembly, they may be realized with different colors, for instance. The mount for the encoding element may be embodied in the form of holes, for example, which are sufficient for engagement by the centering pins which also engage in the openings 14 in the substrate 10.

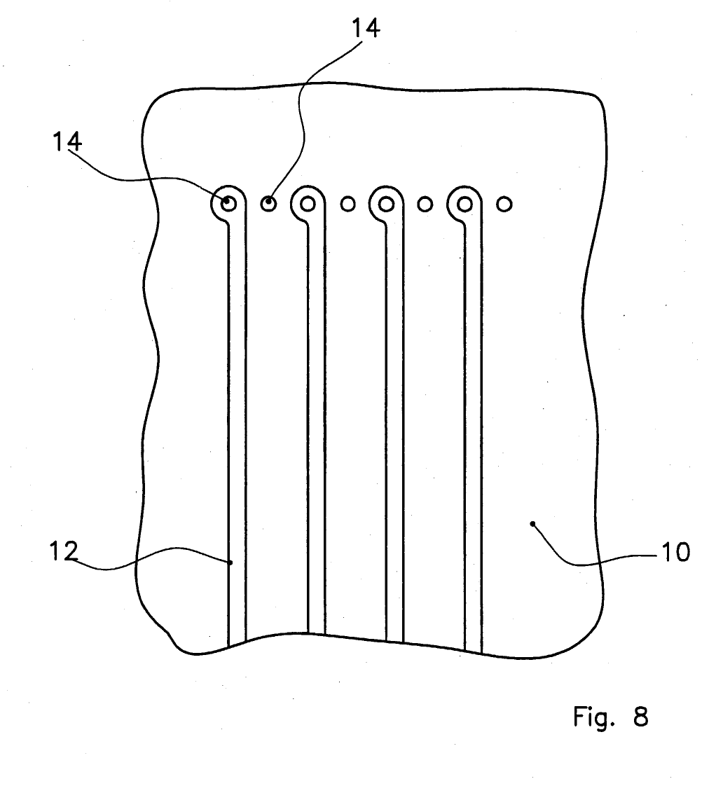

FIG. 8 shows that portion of the substrate 10 which is exposed in the area of the address component 36 in which the encoding element 16 is attached, with the substrate being shown in the initial condition in FIG. 8, i.e. prior to the fitting of the encoding element 16. In the initial condition all of the conductor tracks 12 are intact. It should be appreciated that even in its initial condition, the substrate, too, has a first encoded condition which may be enquired, that is, an encoding with all of the conductor tracks intact.

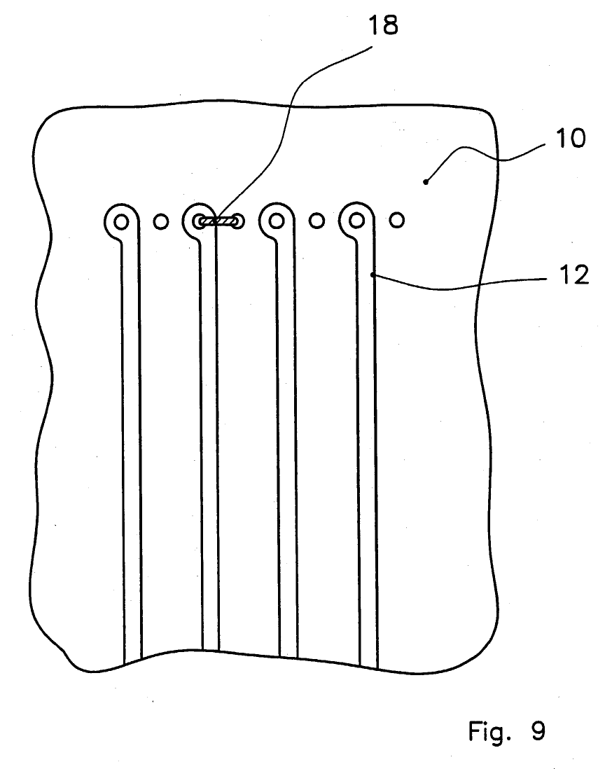

The portion of the substrate 10 illustrated in FIG. 9 is the same as that shown in FIG. 8, with the difference that an encoding element has been fitted whose cutting edge 18 has severed the second conductor track 12 from the left. The address circuit 38 detects by means of a resistance measurement which one of the different conductor tracks 12 is disrupted and, in dependence hereon, assigns a particular address to the electric module 30. It is under this address that the electric module communicates via the bus system.

As a departure from the embodiment shown, the encoding element 16 may also disrupt a plurality of the conductor tracks 12. In this way, the number of possible addresses may be increased.

List of Reference Numerals:

10: substrate

12: conductor track

14: opening

16: encoding element

18: cutting edge

20: holding part

22: centering pin

24: contact surface

26: cutting die plate

28: deflection surface

30: electric module

32: sensor

34: sensor circuit

36: address component

38: address circuit

1. An encoding element for an electric module, said encoding element comprising at least one cutting edge which is provided to sever one of a plurality of conductor tracks arranged on a substrate, whereby said electric module is assigned an address.

2. The encoding element according to claim 1, wherein said cutting edge is made of an electrically insulating material.

3. The encoding element according to claim 1, wherein said cutting edge is made of metal and is embedded in a holding part made of an electrically insulating material.

4. The encoding element according to claim 1, wherein said cutting edge is provided on one side thereof with a curved deflection surface.

5. The encoding element according to claim 4, wherein on an opposite side thereof said cutting edge is likewise provided with a curved deflection surface.

6. The encoding element according to claim 4, wherein on an opposite side thereof said cutting edge is provided with a flat contact surface.

7. The encoding element according to claim 1, wherein at least one centering pin is provided which is adapted to engage in an opening in said substrate.

8. The encoding element according to claim 7, wherein two centering pins are provided and said cutting edge extends between said centering pins.

9. The encoding element according to claim 7, wherein said opening is designed to act as a tear stop means.

10. The encoding element according to claim 7, wherein a notch is formed at an edge of said opening which facilitates initial tearing of said substrate.

11. The encoding element according to claim 1, wherein said cutting edge is formed of two obliquely arranged sections.

12. The encoding element according to claim 1, wherein it is designed as a mating connector which may be plugged into said electric module.

13. The encoding element according to claim 12, wherein it is arranged on said electric module, said module having a single mount for said encoding element.

14. The encoding element according to claim 1, wherein it is designed as a slide which is shiftably arranged on said electric module.

15. An electric module comprising a substrate having a plurality of conductor tracks arranged thereon, and comprising a mount for an encoding element including at least one cutting edge which is provided to selectively sever one of a plurality of conductor tracks arranged on said substrate, whereby said electric module is assigned an address.
